(19) United States
(12) Patent Application Publication
(10) Pub. No.: US 2026/0341693 A1
(43) Pub. Date: Oct. 29, 2026

(54) ONE-DIMENSIONAL LITHIUM MANGANESE OXIDE NANORODS WITH CONTROLLABLE DIAMETER, AND PREPARATION METHOD THEREFOR AND USE THEREOF

(71) Applicant: Kunming University of Science and Technology, Kunming (CN)

(72) Inventors: Yannan ZHANG, Kunming (CN); Bao ZHANG, Kunming (CN); Peng DONG, Kunming (CN); Yingjie ZHANG, Kunming (CN)

(73) Assignee: Kunming University of Science and Technology, Kunming (CN)

(21) Appl. No.: 19/646,629

(22) Filed: Apr. 14, 2026

(30) Foreign Application Priority Data
Apr. 24, 2025 (CN) 202510520704.X

(51) Int. Cl. H01M 4/505; C01G 45/1257

(52) U.S. Cl. CPC H01M 4/505; C01G 45/1257; C01P 2004/16

(57) ABSTRACT

One-dimensional lithium manganese oxide nanorods with controllable diameter, and a preparation method therefor and use thereof are provided. Manganese sulfate, potassium permanganate, a structure-directing agent, and a surfactant are dispersed in a solvent to perform a hydrothermal reaction, thereby obtaining a black precipitate. The black precipitate is subsequently calcined to obtain manganese dioxide nanorods. The manganese dioxide nanorods are then mixed with lithium hydroxide and subjected to a two-step calcination process to obtain one-dimensional lithium manganese oxide nanorods. The nanorods exhibit uniform diameter and very low surface energy. When used as cathode materials, the nanorods can effectively shorten lithium-ion transport paths, resist agglomeration, and possess good flexibility. During long-term operation under high current, the nanorods can maintain structural integrity, which is favorable for improving electrode rate capability and cycling performance.

### CROSS REFERENCE TO THE RELATED APPLICATIONS

This application is based upon and claims priority to Chinese Patent Application No. 202510520704.X, filed on Apr. 24, 2025, the entire contents of which are incorporated herein by reference.

### TECHNICAL FIELD

The present invention relates to the technical field of lithium-ion battery electrode materials, and in particular, to one-dimensional lithium manganese oxide nanorods with controllable diameter, and a preparation method therefor and use thereof.

### BACKGROUND

Lithium-ion batteries, as important electrochemical energy storage devices, have been widely applied in electric vehicles, hybrid vehicles, energy storage facilities, and consumer electronic components. Spinel-type LiMn₂O₄ cathode materials, due to the relatively stable charge-discharge plateau, excellent thermal stability, low production cost, and environmental friendliness, have broad application prospects as substitutes for commercial cobalt-based and nickel-based cathode materials in 3C electronic products and low-speed electric vehicle batteries.

However, commercialized spinel-type LiMn₂O₄ cathode materials are composed of aggregated particles of micron scale or larger. During charge-discharge cycles, lithium-ion diffusion and electron transport paths are relatively long, limiting further commercialization. Compared with micron-scale materials, one-dimensional LiMn₂O₄ materials (such as nanowires, nanorods, and nanotubes) can effectively shorten Li⁺ diffusion distances and electron transport paths, while also exhibiting resistance to aggregation and good flexibility. During long-term operation under high current, the one-dimensional structures maintain structural integrity, resulting in excellent electrochemical performance and promising application prospects. However, traditional preparation methods have difficulty in precisely controlling the diameter of one-dimensional materials, making it challenging to meet specific battery requirements.

Therefore, providing one-dimensional lithium manganese oxide nanorods with controllable diameter, and a preparation method therefor and use thereof, is a technical problem urgently to be solved in the prior art.

### SUMMARY

In view of this, the present invention provides one-dimensional lithium manganese oxide nanorods with controllable diameter, and a preparation method therefor and use thereof, thereby solving the problems of difficulty in size control and non-uniformity associated with conventional methods.

To achieve the above objective, the present invention adopts the following technical solutions.

A preparation method for one-dimensional lithium manganese oxide nanorods with controllable diameter includes the following steps:
1) dispersing manganese sulfate, potassium permanganate, a structure-directing agent, and a surfactant in a solvent to perform a hydrothermal reaction, thereby obtaining a black precipitate;
2) calcining the black precipitate to obtain manganese dioxide nanorods; and
3) mixing the manganese dioxide nanorods with lithium hydroxide and performing a two-step calcination to obtain one-dimensional lithium manganese oxide nanorods; wherein
in the step 1), according to the hydrothermal reaction system, the potassium permanganate has a molar concentration of 0.06-0.15 mmol/L, and the hydrothermal reaction is performed at 120-160 °C; and
the structure-directing agent includes polyethylene glycol.

Preferably, a molar ratio of the manganese sulfate to the potassium permanganate is 1:0.5-2, and
a molar-volume ratio of the potassium permanganate, the structure-directing agent, and the surfactant is 0.06-0.15 mmol:5-10 mL:5-10 mL.

Preferably, the surfactant includes one or more of ethanol, isopropanol, isobutanol, and n-pentanol; and
the solvent is water.

Preferably, the hydrothermal reaction in the step 1) is performed for 8-12 h.

Preferably, the calcination in the step 2) is performed at 400-500 °C for 2-4 h.

Preferably, a molar ratio of the manganese dioxide nanorods to the lithium hydroxide in the step 3) is 2:1-1.05.

Preferably, the two-step calcination includes a first calcination and a second calcination;
the first calcination is performed at 400-500 °C for 4-6 h; and
the second calcination is performed at 650-750 °C for 10-12 h.

Another objective of the present invention is to provide one-dimensional lithium manganese oxide nanorods obtained by the preparation method described above, where the nanorods have a diameter of 30-500 nm and a length of 2-6 μm.

Yet another objective of the present invention is to provide use of the one-dimensional lithium manganese oxide nanorods as a cathode material.

It can be known from the technical solutions that, compared with the prior art, the present invention has the following beneficial effects:

1. The one-dimensional lithium manganese oxide nanorods prepared by the present invention exhibit uniform diameter and very low surface energy. Under hydrothermal conditions, manganese salts of different concentrations first form [MnOₓ] structural units, which, under the hydrothermal reaction temperature defined in the present invention and the action of a structure-directing agent, undergo stable directional curling, thereby obtaining manganese dioxide with uniform cross-sectional diameter.

2. By adjusting the concentration of potassium permanganate and the hydrothermal reaction temperature, the interfacial diameter of manganese dioxide can be precisely controlled, enabling controllable preparation of one-dimensional lithium manganese oxide nanorods.

3. The one-dimensional lithium manganese oxide nanorods prepared by the method of the present invention possess smooth surfaces and uniform diameters. When used as cathode materials, the nanorods can effectively shorten lithium-ion transport paths, resist aggregation, and exhibit good flexibility. During long-term operation under high current, the nanorods maintain structural integrity, which is favorable for improving electrode rate capability and cycling performance.

4. The LiMn₂O₄ cathode materials prepared by the method of the present invention, when cycled at 3.0-4.3 V and 1C charge-discharge, maintain nearly no capacity decay after 100 cycles at room temperature, and retain more than 90% of capacity after 100 cycles at 55 °C. The present invention imposes low requirements on synthesis equipment, features simple operation, requires no special conditions for the calcination process, and is environmentally friendly.

### BRIEF DESCRIPTION OF THE DRAWINGS

To more clearly illustrate the technical solutions in the examples of the present invention or in the prior art, the drawings required to be used in the description of the examples or the prior art are briefly introduced below. It is obvious that the drawings in the description below are merely examples of the present invention, and those of ordinary skill in the art can obtain other drawings according to the drawings provided without creative efforts.

FIG. 1 is an X-ray diffraction (XRD) pattern of one-dimensional lithium manganese oxide nanorods prepared in Embodiments 1-4 of the present invention;

FIGS. 2A-2D are scanning electron microscope (SEM) images of one-dimensional lithium manganese oxide nanorods prepared in Embodiments 1-4 of the present invention, where FIG. 2A is the SEM image of the nanorods prepared in Embodiment 1, FIG. 2B is the SEM image of the nanorods prepared in Embodiment 2, FIG. 2C is the SEM image of the nanorods prepared in Embodiment 3, and FIG. 2D is the SEM image of the nanorods prepared in Embodiment 4; and

FIG. 3 is a graph showing the electrochemical performance curves at different rates of a battery assembled with one-dimensional lithium manganese oxide nanorods prepared in Embodiments 1-4 of the present invention.

### DETAILED DESCRIPTION OF THE EMBODIMENTS

The present invention provides a preparation method for one-dimensional lithium manganese oxide nanorods with controllable diameter, which includes the following steps:
1) dispersing manganese sulfate, potassium permanganate, a structure-directing agent, and a surfactant in a solvent to perform a hydrothermal reaction, thereby obtaining a black precipitate;
2) calcining the black precipitate to obtain manganese dioxide nanorods; and
3) mixing the manganese dioxide nanorods with lithium hydroxide and performing a two-step calcination to obtain one-dimensional lithium manganese oxide nanorods.

In the present invention, in the hydrothermal reaction system of the step 1), the molar concentration of potassium permanganate is 0.06-0.15 mmol/L, specifically 0.08 mmol/L, 0.1 mmol/L, 0.11 mmol/L, 0.12 mmol/L, 0.13 mmol/L, or 0.14 mmol/L; and the hydrothermal reaction temperature is 120-160 °C, specifically 125 °C, 130 °C, 135 °C, 140 °C, 145 °C, 150 °C, or 155 °C.

In the present invention, the diameter of the one-dimensional lithium manganese oxide nanorods increases with the increase of hydrothermal reaction temperature and increases with the increase of potassium permanganate concentration. The diameters of one-dimensional lithium manganese oxide nanorods under different hydrothermal reaction temperatures and potassium permanganate concentrations are shown in Table 1.

TABLE 1
Diameters of one-dimensional lithium manganese oxide nanorods
under different temperatures and concentrations

| | Concentration | | | |
|---|---|---|---|---|
| | 0.06-0.08 | 0.08-0.10 | 0.10-0.12 | 0.12-0.15 |
| Temperature | mmol/L | mmol/L | mmol/L | mmol/L |
| 120-140 °C | 30-40 nm | 60-80 nm | 100-120 nm | 140-160 nm |
| 140-160 °C | 40-60 nm | 80-100 nm | 120-140 nm | 160-180 nm |

In the present invention, the structure-directing agent includes polyethylene glycol.

In the present invention, the molar ratio of the manganese sulfate to the potassium permanganate is 1:0.5-2, preferably 1:0.8-1.5, and more preferably 1:1.

In the present invention, the molar-volume ratio of the potassium permanganate, the structure-directing agent, and the surfactant is 0.06-0.15 mmol:5-10 mL:5-10 mL, preferably 0.1-0.14 mmol:6-9 mL:6-9 mL, and more preferably 0.12 mmol:8 mL:8 mL.

In the present invention, the surfactant includes one or more of ethanol, isopropanol, isobutanol, and n-pentanol; and the solvent is water.

In the present invention, the hydrothermal reaction in the step 1) is performed for 8-12 h, specifically 8 h, 9 h, 10 h, 11 h, or 12 h.

In the present invention, before sintering, the black precipitate further undergoes sequential washing, filtration, and freeze-drying.

In the present invention, the sintering in the step 2) is performed at 400-500 °C, specifically 420 °C, 440 °C, 450 °C, 460 °C, or 480 °C; and the sintering is performed for 2-4 h, specifically 2.2 h, 2.5 h, 2.8 h, 3 h, 3.2 h, 3.5 h, or 3.8 h.

In the present invention, the molar ratio of the manganese dioxide nanorods to the lithium hydroxide in the step 3) is 2:1-1.05, preferably 2:1.01-1.04, and more preferably 2:1.02.

In the present invention, the two-step calcination includes a first calcination and a second calcination.

In the present invention, the first sintering is performed at a temperature of 400-500 °C, specifically 420 °C, 440 °C, 450 °C, 460 °C, or 480 °C, and the first sintering is performed for 4-6 h, specifically 4.2 h, 4.5 h, 4.8 h, 5 h, 5.2 h, 5.5 h, or 5.8 h; and the second sintering is performed at a temperature of 650-750 °C, specifically 660 °C, 680 °C, 700 °C, 720 °C, or 740 °C, and the second sintering is performed for 10-12 h, specifically 10 h, 10.5 h, 11 h, 11.5 h, or 12 h.

The present invention further provides a one-dimensional lithium manganese oxide nanorod prepared by the method. The one-dimensional lithium manganese oxide nanorod has a diameter of 30-500 nm, specifically 40 nm, 50 nm, 80 nm, 100 nm, 150 nm, 200 nm, 250 nm, 300 nm, 350 nm, 400 nm, or 450 nm; and a length of 2-6 μm, specifically 2 μm, 3 μm, 4 μm, 5 μm, or 6 μm.

The present invention further provides use of the one-dimensional lithium manganese oxide nanorods as a cathode material.

The technical solutions in the examples of the present invention will be clearly and completely described below. Apparently, the described examples are merely a part, rather than all of the examples of the present invention. All other embodiments obtained by those of ordinary skill in the art based on embodiments of the present invention without creative efforts shall fall within the protection scope of the present invention.

### Example 1

0.006 mmol of KMnO₄ and 0.008 mmol of MnSO₄·H₂O were weighed according to the molar ratio and added into a beaker. 100 mL of water was added to the beaker, followed by 0.5 mL of polyethylene glycol and 0.5 mL of isopropanol (the molar concentration of KMnO₄ was 0.06 mmol/L). The mixture was stirred on a magnetic stirrer until the solids were completely dissolved. The resulting homogeneous solution was transferred into an autoclave, which was sealed and placed in a drying oven set at 160 °C for 8 h for hydrothermal reaction. After the hydrothermal reaction, the resulting black precipitate was washed with deionized water and ethanol, filtered, and then dried in a freeze dryer. The obtained black powder was placed in a muffle furnace and heated to 400 °C at a rate of 5 °C/min, maintained for 2 h, and then cooled to room temperature with the furnace to obtain manganese dioxide nanorods. The obtained manganese dioxide nanorods were fully mixed with lithium hydroxide in a molar ratio of 2:1.05, and subjected to two-step calcination in a muffle furnace at a heating rate of 5 °C/min. First, the mixture was calcined at 450 °C for 4 h, and then the temperature was raised to 750 °C for 12 h. After cooling with the furnace, one-dimensional lithium manganese oxide nanorods were obtained, referred to as LMO-1.

### Example 2

0.009 mmol of KMnO₄ and 0.008 mmol of MnSO₄·H₂O were weighed according to the molar ratio and added into a beaker. 100 mL of water was added to the beaker, followed by 0.5 mL of polyethylene glycol and 0.5 mL of isopropanol (the molar concentration of KMnO₄ was 0.09 mmol/L). The mixture was stirred on a magnetic stirrer until the solids were completely dissolved. The resulting homogeneous solution was transferred into an autoclave, which was sealed and placed in a drying oven set at 160 °C for 8 h for hydrothermal reaction. After the hydrothermal reaction, the resulting black precipitate was washed with deionized water and ethanol, filtered, and then dried in a freeze dryer. The obtained black powder was placed in a muffle furnace and heated to 400 °C at a rate of 2 °C/min, maintained for 2 h, and then cooled to room temperature with the furnace to obtain manganese dioxide nanorods. The obtained manganese dioxide nanorods were fully mixed with lithium hydroxide in a molar ratio of 2:1.05, and subjected to two-step calcination in a muffle furnace at a heating rate of 5 °C/min. First, the mixture was calcined at 400 °C for 5 h, and then the temperature was raised to 700 °C for 10 h. After cooling with the furnace, one-dimensional lithium manganese oxide nanorods were obtained, referred to as LMO-2.

### Example 3

0.012 mmol of KMnO₄ and 0.008 mmol of MnSO₄·H₂O were weighed according to the molar ratio and added into a beaker. 100 mL of water was added to the beaker, followed by 0.5 mL of polyethylene glycol and 0.5 mL of isopropanol (the molar concentration of KMnO₄ was 0.12 mmol/L). The mixture was stirred on a magnetic stirrer until the solids were completely dissolved. The resulting homogeneous solution was transferred into an autoclave, which was sealed and placed in a drying oven set at 120 °C for 12 h for hydrothermal reaction. After the hydrothermal reaction, the resulting black precipitate was washed with deionized water and ethanol, filtered, and then dried in a freeze dryer. The obtained black powder was placed in a muffle furnace and heated to 450 °C at a rate of 4 °C/min, maintained for 2 h, and then cooled to room temperature with the furnace to obtain manganese dioxide nanorods. The obtained manganese dioxide nanorods were fully mixed with lithium hydroxide in a molar ratio of 2:1.05, and subjected to two-step calcination in a muffle furnace at a heating rate of 4 °C/min. First, the mixture was calcined at 500 °C for 6 h, and then the temperature was raised to 650 °C for 12 h. After cooling with the furnace, one-dimensional lithium manganese oxide nanorods were obtained, referred to as LMO-3.

### Example 4

0.015 mmol of KMnO₄ and 0.008 mmol of MnSO₄·H₂O were weighed according to the molar ratio and added into a beaker. 100 mL of water was added to the beaker, followed by 0.5 mL of polyethylene glycol and 0.5 mL of isopropanol (the molar concentration of KMnO₄ was 0.15 mmol/L). The mixture was stirred on a magnetic stirrer until the solids were completely dissolved. The resulting homogeneous solution was transferred into an autoclave, which was sealed and placed in a drying oven set at 140 °C for 10 h for hydrothermal reaction. After the hydrothermal reaction, the resulting black precipitate was washed with deionized water and ethanol, filtered, and then dried in a freeze dryer. The obtained black powder was placed in a muffle furnace and heated to 500 °C at a rate of 3 °C/min, maintained for 3 h, and then cooled to room temperature with the furnace to obtain manganese dioxide nanorods. The obtained manganese dioxide nanorods were fully mixed with lithium hydroxide in a molar ratio of 2:1.05, and subjected to two-step calcination in a muffle furnace at a heating rate of 3 °C/min. First, the mixture was calcined at 400 °C for 6 h, and then the temperature was raised to 700 °C for 10 h. After cooling with the furnace, one-dimensional lithium manganese oxide nanorods were obtained, referred to as LMO-4.

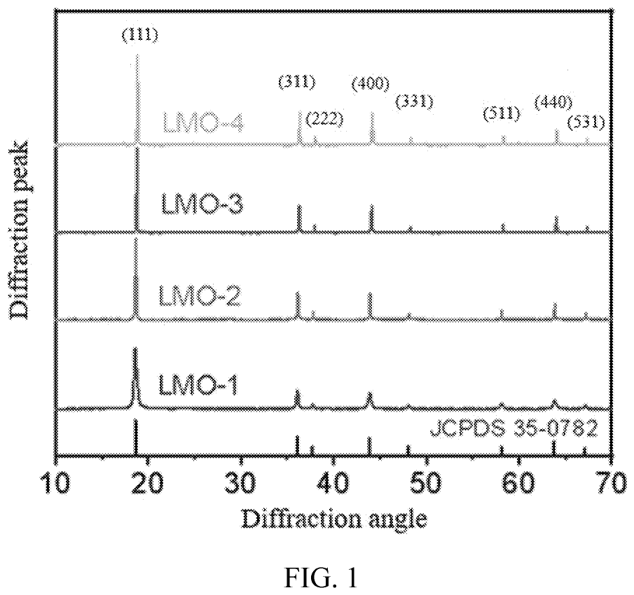

The X-ray diffraction (XRD) patterns of one-dimensional lithium manganese oxide nanorods prepared in Examples 1-4 are shown in FIG. 1. As shown in FIG. 1, all diffraction peaks of the cathode materials corresponded to LiMn₂O₄ (standard card number: PDF #35.0782) with Fd3m space group, indicating that the samples are high-purity LiMn₂O₄.

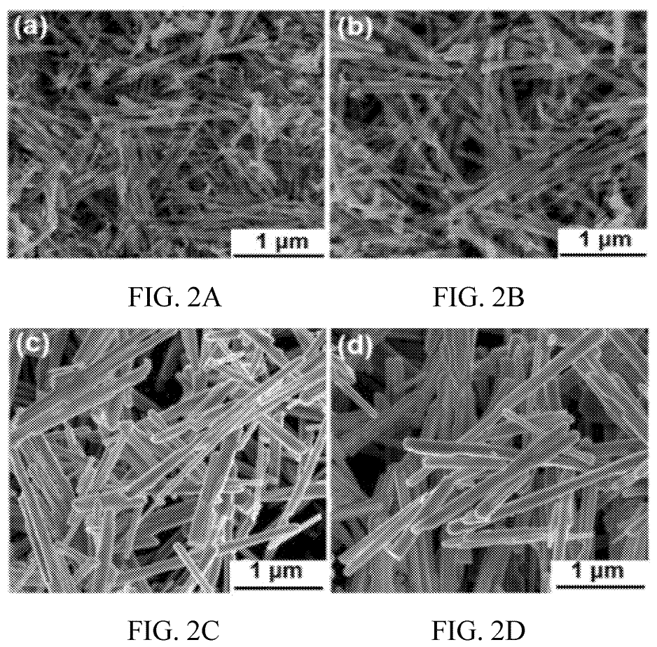

The scanning electron microscopy (SEM) images are shown in FIGS. 2A-2D. In FIGS. 2A-2D, where FIG. 2A shows the SEM image of one-dimensional lithium manganese oxide nanorods prepared in Example 1, FIG. 2B shows the SEM image of one-dimensional lithium manganese oxide nanorods prepared in Example 2, FIG. 2C shows the SEM image of one-dimensional lithium manganese oxide nanorods prepared in Example 3, and FIG. 2D shows the SEM image of one-dimensional lithium manganese oxide nanorods prepared in Example 4. As shown in FIGS. 2A-2D, all samples exhibit typical one-dimensional nanorod morphology. The average diameters of the nanorods prepared in Examples 1-4 are approximately 30-60 nm, 60-100 nm, 100-140 nm, and 140-180 nm, respectively. The diameters are uniform, the surfaces are smooth, and the aspect ratios are greater than 20:1.

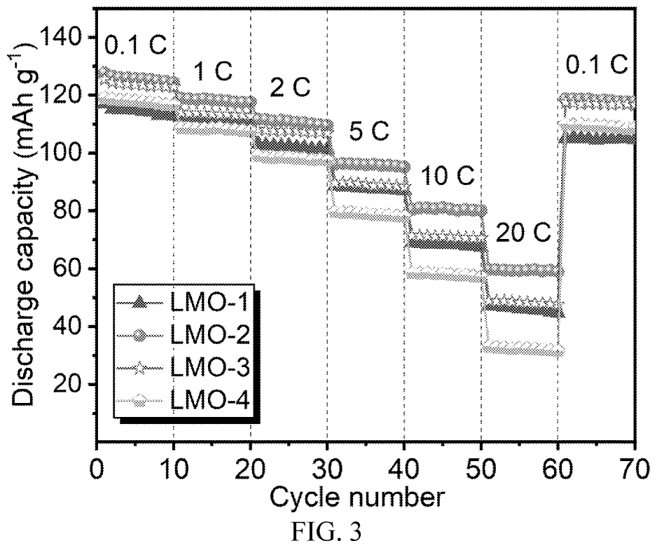

The one-dimensional lithium manganese oxide nanorods prepared in Examples 1-4 were used as cathode materials for battery assembly. The assembly method was as follows: 2025-type coin cells were used as the test platform for battery performance. LiMn₂O₄ was coated on aluminum foil discs to serve as the cathode, metallic lithium discs served as the anode, and 1 mol/L LiPF₆ (dissolved in a mixed solvent of dimethyl carbonate (DMC), ethylene carbonate (EC), and ethyl methyl carbonate (EMC) at a volume ratio of 1:1:1) was used as the electrolyte. The coin cells were assembled in an argon-filled glove box in the following sequence: an anode case, a spacer, a lithium disc, a separator, a cathode disc, a spacer, a spring, and a cathode case. The assembled cells were compacted and sealed using a hydraulic coin cell crimper to obtain 2025-type coin cells. The testing method was as follows: the battery performance was tested using a Neware CT3008 battery tester, and the voltage range was set from 3.0 to 4.5 V. The charge and discharge currents were set according to specific testing requirements. During the current setting, the current density corresponding to a 1C rate of LiMn₂O₄ was 148 mAh·g⁻¹. For rate capability testing, the cells were cycled five times at current densities of 0.1C, 1C, 2C, 5C, 10C, 20C, and 0.1C, respectively. The testing results are shown in FIG. 3. As shown in FIG. 3, all one-dimensional lithium manganese oxide nanorods exhibit good rate capability and cycling stability at high current densities. Specifically, the LMO-2 sample maintains a discharge capacity of 62 mAh·g⁻¹ even at a high current density of 20 C.

Embodiments in this specification are all described in a progressive manner, for same or similar parts in embodiments, reference may be made to these embodiments, and each embodiment focuses on a difference from other embodiments.

The above description of the disclosed embodiments enables those skilled in the art to implement or use the present invention. Various modifications to these embodiments will be readily apparent to those skilled in the art, and the generic principles defined herein may be applied to other embodiments without departing from the spirit or scope of the present invention. Thus, the present invention is not intended to be limited to these embodiments shown herein but is to be accorded the broadest scope consistent with the principles and novel features disclosed herein.

What is claimed is:

1. A preparation method for one-dimensional lithium manganese oxide nanorods with a controllable diameter, comprising the following steps:
1) dispersing manganese sulfate, potassium permanganate, a structure-directing agent, and a surfactant in a solvent to perform a hydrothermal reaction, thereby obtaining a black precipitate;
2) calcining the black precipitate to obtain manganese dioxide nanorods; and
3) mixing the manganese dioxide nanorods with lithium hydroxide and performing a two-step calcination to obtain the one-dimensional lithium manganese oxide nanorods; wherein
in the step 1), according to a hydrothermal reaction system, the potassium permanganate has a molar concentration of 0.06-0.15 mmol/L, and the hydrothermal reaction is performed at 120-160 °C;
the structure-directing agent comprises polyethylene glycol;
the surfactant comprises one or more of ethanol, isopropanol, isobutanol, and n-pentanol;
the two-step calcination comprises a first calcination and a second calcination;
the first calcination is performed at 400-500 °C for 4-6 h; and
the second calcination is performed at 650-750 °C for 10-12 h.

2. The preparation method for the one-dimensional lithium manganese oxide nanorods with the controllable diameter according to claim 1, wherein a molar ratio of the manganese sulfate to the potassium permanganate is 1:0.5-2, and
a molar-volume ratio of the potassium permanganate, the structure-directing agent, and the surfactant is 0.06-0.15 mmol:5-10 mL:5-10 mL.

3. The preparation method for the one-dimensional lithium manganese oxide nanorods with the controllable diameter according to claim 2, wherein the solvent is water.

4. The preparation method for the one-dimensional lithium manganese oxide nanorods with the controllable diameter according to claim 1, wherein the hydrothermal reaction in the step 1) is performed for 8-12 h.

5. The preparation method for the one-dimensional lithium manganese oxide nanorods with the controllable diameter according to claim 4, wherein the calcination in the step 2) is performed at 400-500 °C for 2-4 h.

6. The preparation method for the one-dimensional lithium manganese oxide nanorods with the controllable diameter according to claim 5, wherein a molar ratio of the manganese dioxide nanorods to the lithium hydroxide in the step 3) is 2:1-1.05.

7. One-dimensional lithium manganese oxide nanorods obtained by the preparation method according to claim 1, wherein the nanorods have a diameter of 30-500 nm and a length of 2-6 μm.

8. A use of the one-dimensional lithium manganese oxide nanorods according to claim 7 as a cathode material.

9. The preparation method for the one-dimensional lithium manganese oxide nanorods with the controllable diameter according to claim 2, wherein the hydrothermal reaction in the step 1) is performed for 8-12 h.

10. The preparation method for the one-dimensional lithium manganese oxide nanorods with the controllable diameter according to claim 3, wherein the hydrothermal reaction in the step 1) is performed for 8-12 h.

11. The one-dimensional lithium manganese oxide nanorods according to claim 7, wherein in the preparation method, a molar ratio of the manganese sulfate to the potassium permanganate is 1:0.5-2, and
a molar-volume ratio of the potassium permanganate, the structure-directing agent, and the surfactant is 0.06-0.15 mmol:5-10 mL:5-10 mL.

12. The one-dimensional lithium manganese oxide nanorods according to claim 11, wherein in the preparation method, the solvent is water.

13. The one-dimensional lithium manganese oxide nanorods according to claim 7, wherein in the preparation method, the hydrothermal reaction in the step 1) is performed for 8-12 h.

14. The one-dimensional lithium manganese oxide nanorods according to claim 13, wherein in the preparation method, the calcination in the step 2) is performed at 400-500 °C for 2-4 h.

15. The one-dimensional lithium manganese oxide nanorods according to claim 14, wherein in the preparation method, a molar ratio of the manganese dioxide nanorods to the lithium hydroxide in the step 3) is 2:1-1.05.
